(19) United States
(12) Patent Application Publication
(10) Pub. No.: US 2025/0217639 A1
(43) Pub. Date: Jul. 3, 2025

(54) STAGE-WISE TRAINING FOR MULTI-STAGE NEURAL NETWORKS

(71) Applicant: GM Cruise Holdings LLC, San Francisco, CA (US)

(72) Inventors: Zhe Wang, San Francisco, CA (US); Yichen Shen, Santa Clara, CA (US)

(21) Appl. No.: 18/402,303

(22) Filed: Jan. 2, 2024

(51) Int. Cl. G06N 3/08; G06N 3/045

(52) U.S. Cl. CPC G06N 3/08; G06N 3/045

(57) ABSTRACT

Systems and techniques are provided for multi-stage training of a multi-network system. An example method can include training, using training data, a first neural network during a first training stage; generating, by the first neural network, one or more outputs; based on a determination that the first training stage and training of the first neural network are complete, providing the one or more outputs to a second neural network that has an input data dependency comprising data generated by the first neural network; and based on the determination that the first training stage and training of the first neural network are complete, training, using the one or more outputs from the first neural network, the second neural network during a second training stage initiated after completion of the first training stage.

### TECHNICAL FIELD

The present disclosure generally relates to training neural networks. For example, aspects of the present disclosure relate to techniques and systems for stage-wise training for multi-stage neural networks.

### BACKGROUND

Artificial intelligence (AI) and machine learning (ML) models are increasingly used to perform complicated tasks with a high degree of accuracy. For example, AI/ML models are often used for computer vision tasks, natural language processing, classification tasks, prediction tasks, and automation tasks (e.g., autonomous driving, etc.), among other tasks and/or applications. Moreover, the AI/ML model can be integrated and/or used with other software. For example, an AI/ML model can be integrated and/or used with software used by an autonomous vehicle (AV) to perform autonomous driving operations, such as a perception stack of the AV, a prediction stack of the AV, a planning stack of the AV, a control stack of the AV, and/or a software system(s) of the AV (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

In general, training AI/ML models can be difficult, time-consuming, and costly. For example, the amount of data used to train an AI/ML model to achieve a certain accuracy and/or performance can be very large, and such amount of training data can be difficult to obtain and/or generate. The training process can also be expensive and time-intensive, as it often uses a large number of resources and can involve a large number of training and/or data processing operations. AI/ML models can also be very difficult to train to achieve a desired accuracy and/or performance, particularly when training AI/ML models that depend on other AI/ML models such as AI/ML models that are sequentially implemented after other AI/ML models and/or have dependencies from other AI/ML models, which can impact not only the cost of training the AI/ML models but also the accuracy and performance of such AI/ML models. Thus, the overall training of AI/ML models can be very difficult and can significantly affect the accuracy and performance of the AI/ML models.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations performed by an AV that can implement a multi-network system trained using a multi-stage training process, according to some examples of the present disclosure;

FIG. 2 is a diagram illustrating an example of a multi-network system that includes a set of sequential neural networks, according to some examples of the present disclosure;

FIG. 3 is a diagram illustrating an example of a multi-stage training process for training neural networks in a multi-network system, according to some examples of the present disclosure;

FIG. 4 illustrates an example configuration of a neural network, according to some examples of the present disclosure;

FIG. 5 is a flowchart illustrating an example process for training neural networks in a multi-network system using stage-wise training, according to some examples of the present disclosure; and

FIG. 6 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, artificial intelligence (AI) and machine learning (ML) models are increasingly used to perform a variety of tasks and can often provide a high degree of accuracy. For example, AI/ML models are often used for computer vision, natural language processing, classification, prediction, and automation (e.g., autonomous driving, etc.), among other tasks and/or applications. Moreover, the AI/ML models can be integrated and/or used with other software. To illustrate, an AI/ML model can be integrated and/or used with software used by an autonomous vehicle (AV) to perform various autonomous driving operations such as, for example and without limitation, a perception stack of the AV used for perception tasks, a prediction stack of the AV used for prediction tasks, a planning stack of the AV used for planning tasks, a control stack of the AV used for control tasks, and/or any other software system(s) of the AV used for any other tasks (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

To illustrate, AI/ML models can be implemented by AVs to perform difficult, complex, and/or routine AV tasks and operations. In many cases, the AI/ML models can provide a higher degree of precision than other types of software and/or algorithms. In some examples, an AI/ML model can process data from various sensors of an AV, and use the sensor data to perform various tasks, operations, and/or computations for the AV. In general, an AV can include a motorized vehicle that can navigate without a human driver. To help the AV understand its environment/surroundings and perform autonomous driving operations, the AV can include various sensors, such as a camera sensor(s), a light detection and ranging (LIDAR) sensor(s), a radio detection and ranging (RADAR) sensor(s), a time-of-flight (TOF) sensor(s), an inertial measurement unit(s) (IMU(s)), and/or an acoustic sensor, amongst other sensors. The AV can use the sensors to collect data and measurements associated with an environment, which the AV (e.g., an AI/ML model(s) of the AV and/or other AV software) can use to support and/or perform operations such as navigation, planning, perception, etc. For example, the sensors can provide the data and measurements to an internal computing system of the AV, which can use the data and measurements to control a mechanical system of the AV, such as a vehicle propulsion system, a braking system, or a steering system. In many cases, the internal computing system can implement various AI/ML models used by the internal computing system of the AV to make decisions, make predictions, perform tasks and/or operations, understand the environment, etc.

An AI/ML model can include an AI/ML architecture, platform, software, neural network(s), and/or component(s). For example, an AI/ML model can include an AI/ML development and/or training platform, an AI/ML model architecture, and/or one or more neural networks. AI/ML models generally need to be trained to achieve a desired performance and/or accuracy. However, training AI/ML models can be very difficult and often expensive. For example, the amount of data used to train an AI/ML model in order to achieve a certain accuracy and/or performance can be large and difficult to obtain and/or generate. The training process can also be expensive, as it often uses a large amount of resources and typically involves numerous training and/or data processing operations, as well as time-consuming and often imprecise.

Moreover, some AI/ML models may depend on other AI/ML models, such as AI/ML models that are sequentially implemented after other AI/ML models and/or have dependencies from other AI/ML models (e.g., that depend on data from other AI/ML models). In such scenarios, it can be even more difficult to train the AI/ML models to achieve a certain accuracy and/or performance, as the training process in such cases typically involves training multiple AI/ML models, and a poorly trained AI/ML model can affect the accuracy and/or performance of other AI/ML models implemented with the poorly trained AI/ML model. For example, if an AI/ML model depends on data from a poorly trained AI/ML model, the lower accuracy of the poorly trained AI/ML model (e.g., relative to the accuracy of an AI/ML model trained to achieve better results) can negatively affect the results from the other AI/ML model(s) that depends on data from that poorly trained AI/ML model.

In some examples, the AI/ML models in a set of AI/ML models implemented sequentially may be trained together. For example, a set of AI/ML models implemented sequentially can include a first AI/ML model that is dependent on data from a second AI/ML model (or multiple AI/ML models) in the set of AI/ML models (e.g., the first AI/ML model can be designed/configured to run after the second AI/ML model and use the output(s) from the second AI/ML model as the input of the first AI/ML model, and/or the first AI/ML model can be designed/configured to use an input that is formed at least partly based on the output(s) from the second AI/ML model). To train the set of AI/ML models, the different models in the set of AI/ML models can be trained together (e.g., simultaneously/contemporaneously trained). However, such training approaches can result in lower accuracies and/or performances of the AI/ML models (e.g., their individual outputs and/or their end-to-end output) and, with such training approaches, the training of the AI/ML models may even take more time to achieve a desired accuracy and/or performance of the AI/ML models (e.g., an end-to-end accuracy and/or performance of the set of AI/ML models and/or a respective accuracy and/or performance of each AI/ML model). Moreover, with such training approaches, the training results of the AI/ML models trained together may not accurately reflect the end-to-end performance and/or accuracy of the trained set of AI/ML models.

For example, assume that a set of AI/ML models implemented sequentially includes a first neural network that processes input data to generate an output that is then used as an input to (and/or used to form an input to) a second neural network. Moreover, assume that the first neural network and the second neural network are trained together (e.g., simultaneously/contemporaneously). In this example, the second neural network, which depends on data from the first neural network (e.g., that has data dependencies from the first neural network), may in some cases be trained using the data generated by the first neural network before the first neural network is fully trained (e.g., the data from the first neural network generated during one or more training iterations), and thus is trained with data from the first neural network before the first neural network is trained/able to achieve a desired performance/accuracy. Accordingly, the data from the first neural network used to train the second neural network may be imprecise (e.g., since the training of the first neural network has not completed and the first neural network is thus not sufficiently trained to achieve a desired performance/accuracy), which can have a negative impact on the performance/accuracy of the second neural network and/or the time used to train the second neural network to achieve a desired performance/accuracy.

Moreover, the results from the second neural network during training may not accurately reflect the results from the second neural network when the second neural network is later used to process data generated by the first neural network at an inference stage/phase (e.g., after the first neural network is fully trained to achieve a desired accuracy/performance), as the accuracy/performance of the outputs from the first neural network (which are used as inputs to the second neural network or to form the inputs to the second neural network) during training will differ from the accuracy/performance of the outputs produced by the first neural network once the first neural network is fully trained to achieve a desired accuracy/performance. For example, the outputs generated by the first neural network during training (e.g., before training completes) and used as inputs to (or to form the inputs to) the second neural network may reflect inaccuracies (e.g., errors), which can impact the performance/accuracy of the second neural network (e.g., as such inaccuracies can be propagated and/or accounted in the data generated by the second neural network). In some cases, depending on the architecture of the first and second neural networks, any errors in the data (e.g., outputs) generated by the second neural network during training may even be backpropagated to the first neural network, which can affect the performance/accuracy of the first neural network.

In some cases, if the outputs from the first neural network are not used to train the second neural network (e.g., as inputs to the second neural network) or otherwise used to form the inputs to the second neural network, and the second neural network is instead trained using other data such as training data that is not produced by the first neural network, the results generated by the second neural network based on such training data may not accurately reflect the results of the second neural network (and/or the end-to-end results of the first and second neural networks) when the second neural network is later used to process data from the first neural network after training (e.g., during an inference stage/phase). Here, the accuracy and/or quality of such training data may differ from the accuracy and/or quality of the data produced by the first neural network during or after training, and thus the outputs generated by the second neural network based on such training data may differ from the outputs generated by the second neural network based on data generated by the first neural network during or after training. Moreover, the compilation, review, and/or preparation of such training data used to train the second neural network can be time consuming in comparison with instead using the outputs from the first neural network to train the second neural network.

Systems, apparatuses, processes (also referred to as methods), and computer-readable media (collectively referred to as “systems and techniques”) are described herein for stage-wise training of multi-stage neural networks. In some examples, the systems and techniques described herein can perform a multi-stage training process to train a set of neural networks that are implemented sequentially and/or include at least one neural network that depends on at least another neural network from the set of neural networks. For example, rather than implementing an end-to-end training approach of the set of neural networks, the systems and techniques described herein can train each neural network in the set of neural networks separately, and allow the training to focus on a task and neural network at a time.

To illustrate, if the set of neural networks includes a first neural network that generates an output that is used as an input of (or to form an input of) a second neural network in the set of neural networks, the systems and techniques described herein can first train the first neural network until the first neural network reaches/achieves a desired performance and/or accuracy. Once the training of the first neural network is complete, the parameters of the first neural network when the training is complete can be frozen (e.g., at least until the second neural network is trained) so the parameters of the first neural network are not updated during the training of the second neural network, and the systems and techniques described herein can proceed to training the second neural network. In some examples, the second neural network can be trained using outputs generated by the first neural network when the first neural network training is complete (and the parameters of the first neural network frozen). The outputs from the first neural network can be used as inputs to the second neural network or can be used to form the inputs to the second neural network.

This way, the first and second neural networks can be trained separately and the training can focus on a single neural network (and a single task) at a time. Moreover, with this multi-stage training approach, the second neural network can be trained using data (e.g., inputs) generated by the first neural network after the first neural network is trained so the inputs to the second neural network (e.g., from the data generated by the first neural network) are more accurate than inputs generated by the first neural network before the first neural network training is complete. Also, with the multi-stage training approach, the outputs from the second neural network are not affected by errors/inaccuracies in the data from the first neural network since such outputs are based on data generated by the first neural network after the first neural network is trained to achieve a desired accuracy/performance (or are affected by a lower amount/magnitude of errors/inaccuracies in the data generated by the first neural network relative to the amount/magnitude of errors/inaccuracies in the data generated by the first neural network before training of the first neural network is complete). As a result, the multi-stage training approach can result in a higher individual performance/accuracy of each neural network and a higher end-to-end performance/accuracy of the first and second neural networks. For example, by focusing a first training stage on training the first neural network, the first neural network can be trained to produce more accurate results than if the first and second neural networks are trained together. Further, by using the more accurate results from the trained first neural network as inputs to (or to form the inputs to) the second neural network, the second neural network can also produce more accurate results than if the first and second neural networks are trained together.

In the previous example, the first and second neural networks can represent any type of neural networks where one neural network (e.g., the second neural network) depends on data from the other neural network (e.g., the first neural network) to produce its outputs. In one illustrative example, the first neural network can be a segmentation network used to segment sensor data, such as LIDAR point cloud data, and the second neural network can be a centroid network used to determine a centroid of a target in the segmentation data from the segmentation network. For example, the segmentation network can receive a LIDAR point cloud with a bounding box determined (e.g., via an object detection model/algorithm) for a target in the LIDAR point cloud.

In some cases, the bounding box may include some inaccuracies. For example, the bounding box may include data points in a point cloud foreground corresponding to the target, but may also include data points that do not correspond to the target (such as data points corresponding to a point cloud background). The segmentation network can be trained to generate a segmentation (e.g., a segmented point cloud) that segments/identifies data points corresponding to the foreground (e.g., the target) and data points corresponding to the background (e.g., not the target). Thus, the segmentation can indicate which data points correspond to the target and which data points do not correspond to the target. However, the segmentation may incorrectly identify one or more data points that correspond to the background as foreground (target) data points or include foreground data points within the background data points.

The segmentation network can be trained during one or more training iterations until a desired segmentation performance/accuracy is achieved. Once training of the segmentation network completes, the parameters of the segmentation network can be frozen to prevent updates to such parameters during training of the centroid network, which can be separately trained after training of the segmentation network is complete. The segmentation results from the trained segmentation network (e.g., the segmented point cloud) can be used as inputs to the centroid network during training of the centroid network. In some cases, before the segmentation results are provided as input to the centroid network, the systems and techniques described herein can apply one or more operations to the segmentation results, and provide the modified segmentation results (e.g., after applying the one or more operations) to the centroid network for training. For example, the systems and techniques described herein can apply a point masking operation to the segmentation results in order to remove (e.g., mask) one or more data points that belong to the background (e.g., that do not belong to the target) but are incorrectly included in the bounding box and/or the segmented data points corresponding to the point cloud foreground (e.g., the target). The systems and techniques described herein can then provide the modified segmentation results (e.g., after applying the one or more operations, such as the point masking operation) to the centroid network for training.

The centroid network can be trained to analyze and process the segmented point cloud to identify a centroid of the target in the segmented point cloud. The centroid of the target can include a center point or a three-dimensional (3D) center point of the target, which can be used to better identify the data points corresponding to the target and/or can be used for one or more additional tasks such as, for example and without limitation, tracking, object detection, object recognition, prediction, and/or planning tasks, among other tasks. The centroid network can be separately trained (e.g., separate from the segmentation network) over one or more training iterations using data from the trained segmentation network (e.g., with or without further processing such data using one or more operations, such as a point masking operation) until the centroid network achieves a desired accuracy/performance.

For illustration and explanation purposes the multi-stage training approaches implemented by the systems and techniques described herein are described in the context of a segmentation network and a centroid network implemented in the context of an autonomous vehicle. However, such application and context is merely one illustrative example. As previously noted, the multi-stage training approaches described herein can be used to train neural networks used in any application, context, and/or use case. For example, the multi-stage training approaches described herein can be used to train neural networks used for classification, object detection, object recognition, centroid detection, object tracking, object localization, prediction, computer modeling, other computer vision tasks, robotic applications, unmanned aerial vehicle applications, extended reality (e.g., virtual reality, augmented reality, etc.) applications, autonomous vehicle applications, manufacturing applications, medical device applications, among other applications, contexts, and/or use cases.

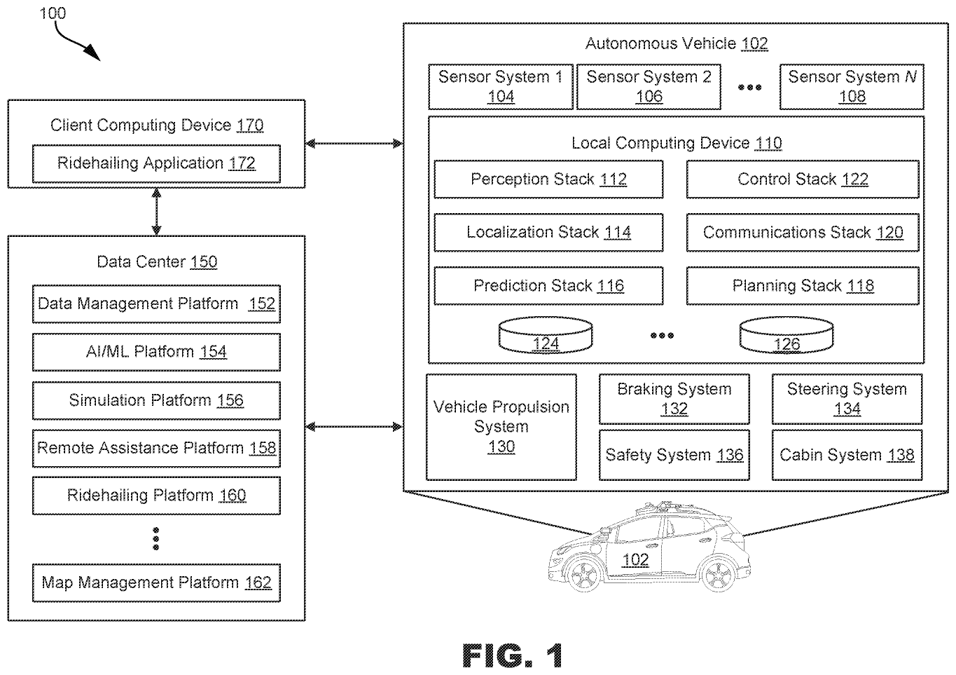

Examples of the systems and techniques described herein for processing data are illustrated in FIG. 1 through FIG. 6 and described below.

In some cases, the multi-stage training described herein can be used to train AI/ML models/software of an autonomous vehicle and/or an autonomous vehicle management system. FIG. 1 illustrates an example autonomous vehicle (AV) management system 100 according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In some examples, the AV management system 100 can be used to facilitate AV navigation and routing operations performed by an AV 102 that can implement a multi-network system trained using a multi-stage training process. In the example shown in FIG. 1, the AV management system 100 includes the AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 to enable passengers to view the AV 102 in transit to a pick-up or drop-off location, and so on.

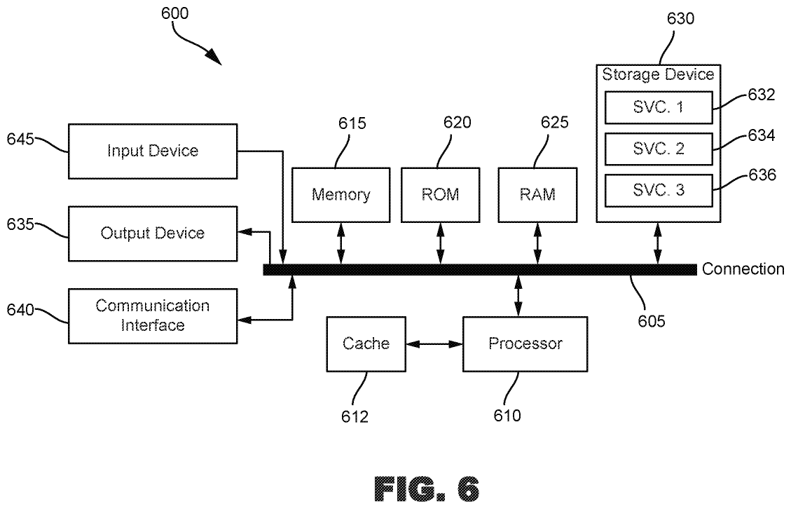

While the AV 102, the local computing device 110, and the autonomous vehicle management system 100 are shown to include certain systems and components, one of ordinary skill will appreciate that the AV 102, the local computing device 110, and/or the autonomous vehicle management system 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

As previously noted, the systems and techniques described herein can perform a multi-stage training process to train a set of neural networks that are implemented sequentially (e.g., a set of neural networks that includes at least one neural network that depends on at least another neural network from the set of neural networks). For example, rather than implementing an end-to-end training approach where the neural networks in the set are trained together (e.g., simultaneously, contemporaneously, in parallel, etc.), the systems and techniques described herein can train each neural network in the set of neural networks separately, with a particular neural network being trained after another neural network is trained, and can thus allow the training to focus on a task and neural network at a time.

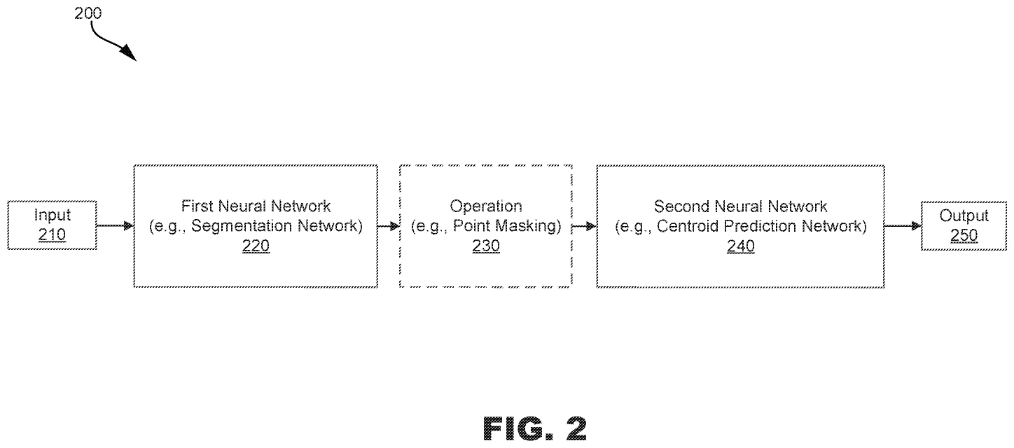

FIG. 2 is a diagram illustrating an example of a multi-network system 200 that includes a set of sequential neural networks, according to some examples of the present disclosure. A set of sequential neural networks can refer to a set of any neural networks where a neural network (or multiple neural networks) of the set depends on data from another neural network (or multiple neural networks) and is thus executed/run/used/etc., after the other neural network. For example, the set of sequential neural networks can include a first neural network (e.g., first neural network 220) and a second neural network (e.g., second neural network 240) that depends on the first neural network (e.g., that depends on data from the first neural network, which is a data dependency of the second neural network) such that the input to the second neural network (e.g., second neural network 240) that depends on the first neural network (e.g., first neural network 220) is generated by the first neural network (e.g., is the output of the first neural network) or is formed using an output of the first neural network.

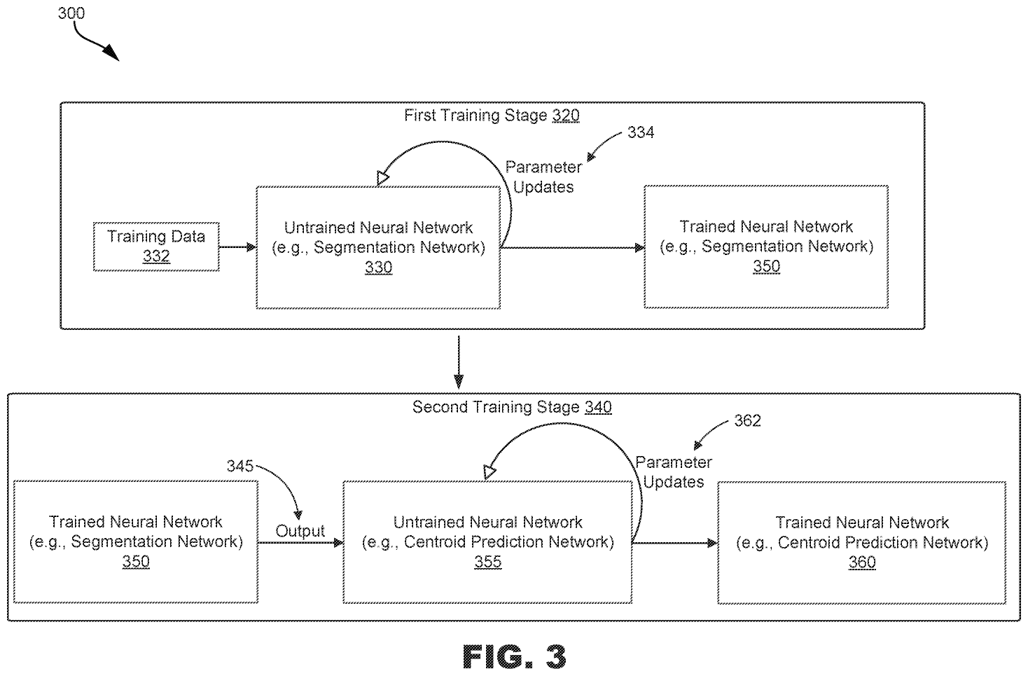

The multi-network system 200 includes an example of a set of sequential neural networks that can be trained according to a multi-stage training process, such as multi-stage training process 300 shown in FIG. 3 and further described herein. In this example, the multi-network system 200 can include a first neural network 220 that is implemented (e.g., run, executed, used, activated, etc.) before a second neural network 240 of the multi-network system 200, because the output(s) (or a portion thereof) from the first neural network 220 is/are used as the input(s) to (or to form the input(s) to) the second neural network 240 (e.g., a data dependency of the second neural network 240 includes data generated by the first neural network 220 or data that is formed using an output(s) of the first neural network 220). Thus, the second neural network 240 depends on the first neural network 220 (e.g., the second neural network 240 includes data dependencies from the first neural network 220) and is sequentially run/executed/activated/used/etc., after the first neural network 220.

As shown in FIG. 2, the first neural network 220 in this example represents a segmentation network and the second neural network 240 represents a centroid prediction network. However, the segmentation network and the centroid prediction network are merely illustrative examples provided for explanation purposes. In other examples, the multi-network system 200 can include any other neural network where at least one neural network depends on data from at least one other neural network (e.g., is sequentially implemented after the at least other neural network). For example, in other cases, the first neural network 220 can represent an object detection network and the second neural network 240 can represent an object recognition network or a classification network.

The first neural network 220 can receive an input 210 for segmentation by the first neural network 220. In some examples, the input 210 can include sensor data from one or more sensors, such as a point cloud from one or more LIDAR sensors on the AV 102, a frame from one or more camera sensors on the AV 102, etc. The input 210 can include a target and optionally a bounding box associated with the target. The first neural network 220 in this example can segment the input 210 to identify portions (e.g., data points, pixels, etc.) that belong to the target (e.g., the foreground) and portions that do not belong to the target (e.g., that belong to a background).

In some examples, the segmentation result from the first neural network 220 can include some inaccuracies where some of the data that does not belong to the target is identified as part of the target (e.g., as part of the foreground). For example, the segmentation result can include within a bounding box associated with the target one or more data points that do not belong to the target. Accordingly, in some cases, the multi-network system 200 can optionally apply an operation 230, such as a point masking operation, to the segmentation result from the first neural network 220 to refine, optimize, and/or modify the segmentation results. For example, the multi-network system 200 can apply a point masking operation (e.g., operation 230) to the segmentation results in order to remove data points identified in the segmentation results as part of the target (e.g., data points included in the bounding box and/or the segmented foreground) that are not actually part of the target (e.g., that are actually background data points that do not belong to the target). This way, the accuracy of the segmentation results produced after the point masking operation is applied can be increased before such segmentation results are fed to the second neural network 240 for processing (e.g., as input to the second neural network 240).

The second neural network 240 (e.g., the centroid prediction network) can receive the output from the first neural network 220 (without application of the operation 230 or after application of the operation 230), which can be used by the second neural network 240 as an input of the second neural network 240 used to generate an output 250. The second neural network 240 can be referred to as a neural network that is sequential to the first neural network 220 in the sense that the second neural network 240 depends on data from the first neural network 220, which is used as at least part of the input to (or to form at least part of the input to) the second neural network 240, and thus is executed sequentially after the first neural network 220 (e.g., directly after the first neural network 220 or after the first neural network 220 and one or more additional algorithms and/or operations, such as the operation 230).

In some cases, the data from the first neural network 220 (and optionally the operation 230) to the second neural network 240 can include the segmentation results and additional information such as, for example and without limitation, semantic and/or local information (e.g., data point location information; data point red, green, blue (RGB) information; a probability that a data point belongs to the target; etc.) associated with the segmentation results. The second neural network 240 (e.g., the centroid prediction network) can use such information to determine a centroid (e.g., output 250) of a target in the segmentation results. For example, the second neural network 240 can use the segmentation results to identify a centroid of the target and, if the data fed to the second neural network 240 includes the additional information (e.g., semantic and/or local information), the second neural network 240 can also use such information to help identify the centroid of the target. To illustrate, a semantic label determined by the first neural network 220 (or any other network) can be provided to the second neural network 240, which the second neural network 240 can use to make a more informed determination of the centroid location. For example, if the semantic information indicates that the target is a vehicle, the second neural network 240 can use such information to more accurately determine the centroid of the target based on one or more features of a vehicle. Similarly, if the semantic information indicates that the target is a human, the second neural network 240 can use such information to more accurately determine the centroid of the target based on one or more features of humans.

While the example multi-network system 200 in FIG. 2 includes two neural networks with one neural network depending on the other neural network, in other examples, the multi-network system 200 can include more neural networks than shown in FIG. 2 and/or can include more dependencies than shown in FIG. 2. For example, in some cases, the multi-network system 200 can include more than two neural networks and a neural network (or more than one neural network) from the neural networks in the multi-network system 200 can depend on data from a single neural network in the multi-network system 200 or more than two neural networks from the multi-network system 200. For example, in some cases, the multi-network system 200 can include n number of neural networks, where n is a number that is greater than two. In this example, a neural network (or multiple neural networks) in the multi-network system 200 can depend on data from one or more other neural networks in the multi-network system 200 (e.g., such data can be used or required as an input to, or to form an input to, the neural network that depends on the one or more other neural networks). Thus, the neural network can be executed/run/implemented/used/etc., sequentially after the one or more other neural networks (e.g., either directly after the one or more other neural networks, or after the one or more other neural networks and one or more algorithms/models and/or operations that are executed/run/implemented/used/etc., after the one or more other neural networks and before that neural network) based on the data dependencies of that neural network (e.g., which depends on data from the one or more other neural networks).

Moreover, as further described herein, to increase the accuracy of the first neural network 220 and/or the second neural network 240 and/or improve the accuracy, effectiveness, quality, and/or performance of the training of the first and second neural networks, the first neural network 220 and the second neural network 240 can be trained in different stages. For example, rather than training the first neural network 220 and the second neural network 240 together (e.g., simultaneously, in parallel, etc.), the first neural network 220 can be trained before the second neural network 240 until the first neural network 220 achieves a desired performance, accuracy, and/or result. Once the first neural network 220 is trained, the parameters of the first neural network 220 can be frozen while the second neural network 240 is then trained until the second neural network 240 achieves a desired performance, accuracy, and/or result. The parameters of the first neural network 220 can be frozen to prevent any updates to the parameters of the first neural network 220 during training of the second neural network 240, as at that point the training of the first neural network 220 has completed.

In some examples, the second neural network 240 can be trained using inputs generated by the first neural network 220 (e.g., with or without applying the operation 230 to the output from the first neural network 220) after the first neural network 220 has been trained. This way, the inputs to the second neural network 240 are more accurate than if such inputs were generated by the first neural network 220 before the first neural network 220 is trained (or before training of the first neural network 220 completes), are more likely to yield more accurate results from the second neural network 240 and/or less likely to reduce an accuracy of the results from the second neural network 240, allow the second neural network 240 to be trained using data that is consistent with (and/or reflective of) the data (e.g., and/or the accuracy, quality, performance, and/or characteristics of the data) produced by the first neural network 220 during an inference/implementation stage and used as an input to (or to form an input to) the second neural network 240, etc.

FIG. 3 is a diagram illustrating an example of a multi-stage training process 300 for training neural networks in a multi-network system (e.g., multi-network system 200), according to some examples of the present disclosure. In this example, the multi-network system includes untrained neural network 330 and untrained neural network 355, and the multi-stage training process 300 is used to train the untrained neural network 330 in a first training stage 320, and the untrained neural network 355 in a second training stage 340. Here, the second training stage 340 used to train untrained neural network 355 is performed after the first training stage 320 is complete (e.g., after training of the untrained neural network 330 is complete).

The untrained neural network 330 and the untrained neural network 355 in the multi-network system can include and/or represent a set of sequential neural networks. A set of sequential neural networks can include and/or refer to a set of neural networks where a neural network (or multiple neural networks) depends on data from another neural network (or multiple neural networks) (e.g., the neural network depends on data from the other neural network for the input to the neural network and/or for information used by the neural network to process inputs. To illustrate, a set of sequential neural networks can include and/or refer to a set of neural networks where the input to a neural network in the set is generated by the other neural network in the set (e.g., the input to the neural network is the output of the other neural network or is based on the output of the other neural network), the input to the neural network in the set is formed using data (e.g., an output) generated by the other neural network, and/or the neural network needs, uses, and/or expects data from the other neural network to process inputs to the neural network.

For example, a neural network in the set of sequential neural networks can depend on data from the other neural network (e.g., for the input to the neural network and/or for the information used by the neural network to generate its output) for the neural network to run/execute and/or generate its output. Therefore, the neural network may be implemented (e.g., executed, run, used, loaded, activated, etc.) sequentially after the other neural network (e.g., with or without applying one or more algorithms/models and/or operations to the data from the other neural network before implementing the neural network) as a result of one or more data dependencies of the neural network (e.g., a data dependency of the neural network includes data from the other neural network). By sequentially implementing the neural network after the other neural network from which the neural network depends, the data from the other neural network (which the neural network at least partially depends on) is available for the neural network when the neural network is implemented.

In some cases, the untrained neural network 330 can represent an untrained version of the first neural network 220 shown in FIG. 2, and the untrained neural network 355 can represent an untrained version of the second neural network 240 shown in FIG. 2. Moreover, the untrained neural network 330 and the untrained neural network 355 in the multi-network system can represent any types of neural networks that are implemented sequentially (e.g., as a result of a data dependency of untrained neural network 355 on data from the trained version of untrained neural network 330 (e.g., trained neural network 350)). For example, in some cases, the untrained neural network 330 can represent a segmentation network, and the untrained neural network 355 can represent a centroid prediction network. In other examples, the untrained neural network 330 and the untrained neural network 355 can represent any other types of neural networks.

As shown in FIG. 3, during the first training stage 320, the untrained neural network 330 is trained using training data 332, such as ground truth data, labeled data, sensor data, a training dataset, and/or any other data. For example, in some cases, the training data 332 can include sensor data, such as a LIDAR point cloud or a camera frame (e.g., a still image or a video frame), that includes a label identifying a target measured, represented, and/or depicted in the data or a bounding box identifying a region in the data corresponding to the target measured, represented, and/or depicted in the data. The untrained neural network 330 can process the training data 332 and calculate an error or loss in the output from the untrained neural network 330.

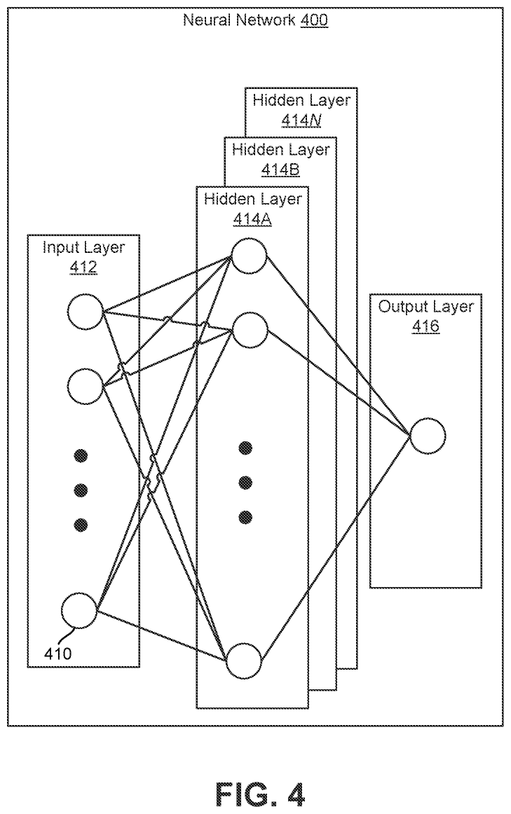

The untrained neural network 330 can use the calculated error or loss in the output to implement parameter updates 334, which can update one or more parameters of the untrained neural network 330 in order to reduce or minimize the difference between the predicted outputs of the untrained neural network 330 and the true/actual and/or target outputs/values. Non-limiting examples of parameters of the untrained neural network 330 (e.g., which can depend on the type of neural network) that can be updated during the first training stage 320 via the parameter updates 334 can include weights (e.g., the weights of connections between neurons), biases (e.g., bias terms of neurons), hyperparameters (e.g., learning rate, number of hidden layers, batch size, number of epochs, etc.), batch normalization parameters (e.g., scale, shift, etc.), dropout probabilities, filters (e.g., convolutional filters/kernels, etc.), recurrent weight matrices, attention weights, and activation functions. An example of a neural network architecture, including neural network parameters and training updates/examples, is illustrated in FIG. 4 and further described below with respect to FIG. 4.

The first training stage 320 can include one or more training iterations used to train the untrained neural network 330. For example, the first training stage 320 can perform multiple training iterations until the untrained neural network 330 achieves a desired performance, accuracy, and/or state. The trained neural network 350 in FIG. 3 represents the untrained neural network 330 after the first training stage 320 is complete (e.g., until training of the untrained neural network 330 is complete). Once the first training stage 320 is complete, the multi-stage training process 300 can proceed to the second training stage 340 where the untrained neural network 355 is trained as described herein. Moreover, when the first training stage 320 is complete, the parameters of the trained neural network 350 can be frozen, at least during training of the untrained neural network 355 at the second training stage 340.

During the second training stage 340, the untrained neural network 355 is trained using an output(s) 345 from the trained neural network 350. For example, if the trained neural network 350 represents a segmentation network, the output(s) 345 from the trained neural network 350 used to train the untrained neural network 355 can include a segmentation output (e.g., a segmentation map, a segmentation mask, segmented sensor data such as segmented image data or segmented point cloud, etc.). In some examples, the untrained neural network 355 can be trained using the output(s) 345 from the trained neural network 350 without further processing of the output(s) 345 from the trained neural network 350 before feeding the output(s) 345 to the untrained neural network 355 for processing (e.g., as an input to the untrained neural network 355). In other examples, the untrained neural network 355 can be trained using the output(s) 345 from the trained neural network 350 after further processing of the output(s) 345 from the trained neural network 350 before feeding such data to the untrained neural network 355 for processing (e.g., as an input to the untrained neural network 355). For example, in some cases, before the output(s) 345 is fed to the untrained neural network 355 for processing during the second training stage 340 (e.g., as input to the untrained neural network 355), an operation(s) (e.g., operation 230), such as a point masking operation, can be applied to the output(s) 345 and the resulting data can be fed to the untrained neural network 355 as an input to the untrained neural network 355 used to train the untrained neural network 355 during the second training stage 340.

The untrained neural network 355 can process the output(s) 345 and calculate an error or loss in the output generated by the untrained neural network 355. The untrained neural network 355 can use the calculated error or loss in the output generated by the untrained neural network 355 to implement parameter updates 362, which can update one or more parameters (e.g., weights, biases, filters, dropout probabilities, hyperparameters, recurrent weight matrices, attention weights, activation functions, batch normalization parameters, etc.) of the untrained neural network 355 in order to reduce or minimize the difference between the predicted outputs of the untrained neural network 355 and the true/actual and/or target outputs/values.

The second training stage 340 can include one or more training iterations used to train the untrained neural network 355. For example, the second training stage 340 can perform multiple training iterations until the untrained neural network 355 achieves a desired performance, accuracy, and/or state. The trained neural network 360 in FIG. 3 represents the untrained neural network 355 after the second training stage 340 is complete (e.g., until training of the untrained neural network 355 is complete). Once the second training stage 340 is complete, the multi-network system can include the trained neural network 350 and the trained neural network 360.

By training the untrained neural network 330 before the untrained neural network 355 and using the output(s) 345 from the trained neural network 350 (which represents the trained version of the untrained neural network 330) as the input(s) to (or to form the input(s) to) the untrained neural network 355 during the second training stage 340, the multi-stage training process 300 can ensure that the input(s) used to train the untrained neural network 355 during the second training stage 340 (e.g., output(s) 345 from the trained neural network 350) is/are more accurate than if such input(s) was/were instead generated by the untrained neural network 330 (e.g., before the untrained neural network 330 is trained in the first training stage 320 or before the first training stage 320 completes), are more likely to yield more accurate results from the untrained neural network 355 during the second training stage 340 and/or the trained neural network 360 after the second training stage 340, is/are less likely to reduce an accuracy of the results (e.g., than inputs from the untrained neural network 330) from the untrained neural network 355 during the second training stage 340 and/or the trained neural network 360 after the second training stage 340, allow the untrained neural network 355 to be trained using data that is consistent with (and/or reflective of) the data (e.g., and/or the accuracy, quality, performance, and/or characteristics of the data) produced by the trained neural network 350 during an inference/implementation stage and used as an input to (or to form an input to) the trained neural network 360 during the inference/implementation stage, etc.

FIG. 4 illustrates an example configuration of a neural network 400 according to some examples of the present disclosure. The neural network 400 can be used to implement any of the neural networks described herein such as, for example, the first neural network 220, the second neural network 240, the untrained neural network 330 and the trained neural network 350, the untrained neural network 355 and the trained neural network 360, etc. Moreover, the neural network 400 can be trained using the multi-stage training approaches described herein. For example, if the neural network 400 is sequentially implemented after another neural network and depends on the other neural network, the neural network 400 can be trained during a second training stage (e.g., second training stage 340) after the other neural network is trained during a first training stage (e.g., first training stage 320), or vice versa. The example configuration in FIG. 4 is merely one illustrative example provided for clarity and explanation purposes. One of ordinary skill in the art will recognize that other configurations of a neural network are possible and contemplated herein.

In FIG. 4, the neural network 400 includes an input layer 412 which includes input data. The input data can include any data such as, for example, image data, acoustic data, sensor data, tensor data, etc. For example, the input data can include sensor data such as a point cloud generated by one or more LIDAR sensors, image data generated by one or more camera sensors, etc. As another example, if the neural network 400 is sequentially implemented after another neural network and depends on data from the other neural network, the input data can include an output from the other neural network or an input to the neural network 400 generated at least in part on an output from the other neural network.

The neural network 400 includes hidden layers 414A through 414N (collectively “414” hereinafter). The hidden layers 414 can include n number of hidden layers, where n is an integer greater than or equal to one. The number of hidden layers can be made to include as many layers as needed for a given application. The neural network 400 further includes an output layer 416 that provides an output resulting from the processing performed by the hidden layers 414. In one illustrative example, the output layer 416 can provide a prediction, classification, content item, a segmentation output, and/or any other type of output.

The neural network 400 can include a multi-layer deep learning network of interconnected nodes. Each node can represent a piece of information. Information associated with the nodes is shared among the different layers. In some examples, each layer can retain information as information is processed. In some cases, the neural network 400 can include a feedforward network, in which case there are no feedback connections where outputs of the network are fed back into itself. For example, the neural network 400 can implement a backpropagation algorithm for training the feedforward neural network. In some cases, the neural network 400 can include a recurrent neural network, which can have loops that allow information to be carried across nodes while reading in input.

Information can be exchanged between nodes (e.g., node 410) through node-to-node interconnections between the various layers. Nodes of the input layer 412 can activate a set of nodes in the first hidden layer 414A. For example, as shown, each of the input nodes of the input layer 412 is connected to each of the nodes of the first hidden layer 414A. The nodes of the hidden layer 414A can transform the information of each input node by applying activation functions to the information. The information derived from the transformation can be passed to and can activate the nodes of the next hidden layer (e.g., 414B), which can perform their own designated functions. Example functions include convolutional, up-sampling, data transformation, pooling, filtering, and/or any other suitable functions. The output of the hidden layer (e.g., 414B) can activate nodes of the next hidden layer (e.g., 414N), and so on. The output of the last hidden layer can activate one or more nodes of the output layer 416, at which point an output is provided. In some cases, while nodes (e.g., node 410) in the neural network 400 are shown as having multiple output lines, a node has a single output and all lines shown as being output from a node represent the same output value.

In some cases, each node or interconnection between nodes can have a weight that is a set of parameters derived from training the neural network 400. For example, an interconnection between nodes can represent a piece of information learned about the interconnected nodes. The interconnection can have a numeric weight that can be tuned (e.g., based on a training dataset), allowing the neural network 400 to be adaptive to inputs and able to learn as more data is processed.

The neural network 400 can be trained to process features from the data in the input layer 412 using the different hidden layers 414 in order to provide the output through the output layer 416. In an example in which the neural network 400 is used to segment image data, the neural network 400 can be trained using image data with a label identifying a target (and/or a foreground) and/or a bounding box containing the target (and/or the foreground).

In some cases, the neural network 400 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 400 is trained enough so that the weights of the layers are accurately tuned.

In an example of segmenting data, the forward pass can include passing a training image or point cloud through the neural network 400. The weights can be initially randomized before the neural network 400 is trained.

For a first training iteration for the neural network 400, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 400 is unable to determine low level features and thus cannot make an accurate determination of what the classification of the object might be. A loss function can be used to analyze errors in the output. Any suitable loss function definition can be used.

The loss (or error) can be higher for the first training inputs since the actual values will be different than the predicted output. The goal of training is to minimize the amount of loss so that the predicted output is the same as a ground truth or training sample. The neural network 400 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 400 can include any suitable deep network. For example, the neural network 400 can include a convolutional neural network (CNN), a recurrent neural network, a U-Net, a DCT-Network, an artificial neural network, an encoder-decoder network, a deep belief net (DBN), an autoencoder, a generative adversarial model, an R-CNN, a fully-connected network (FCN), a transformer network, and/or any other deep neural network. An illustrative example of a neural network (e.g., neural network 400) can include a CNN. The CNN can include an input layer, one or more hidden layers, and an output layer, as previously described. The hidden layers of a CNN can include a series of convolutional, nonlinear, pooling (e.g., for down sampling), and fully connected layers.

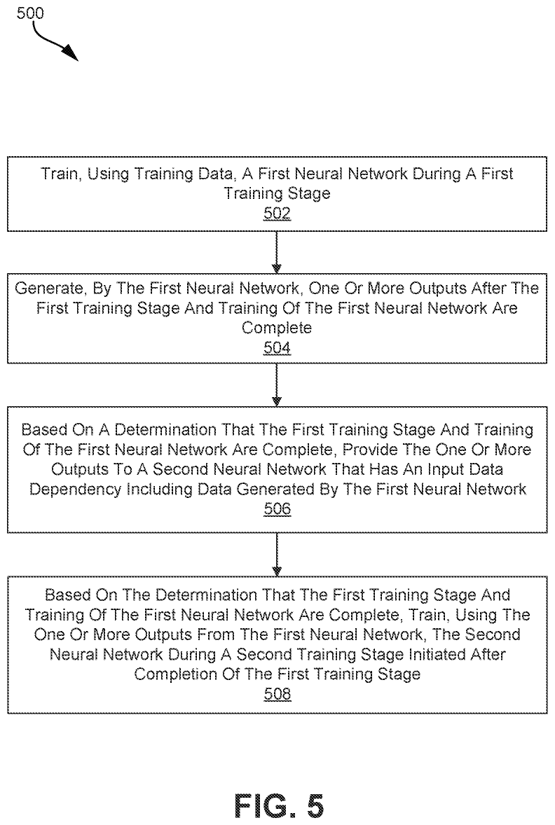

FIG. 5 is a flowchart illustrating an example process 500 for training neural networks in a multi-network system using stage-wise training, according to some examples of the present disclosure. At block 502, the process 500 can include training, using training data (e.g., training data 332), a first neural network (e.g., untrained neural network 330) during a first training stage (e.g., first training stage 320).

At block 504, the process 500 can include generating, by the first neural network, one or more outputs. In some examples, the one or more outputs can include an output(s) generated by the first neural network after the first training stage and training of the first neural network are complete (and/or are determined to be complete).

At block 506, the process 500 can include providing, based on a determination that the first training stage and training of the first neural network are complete, the one or more outputs (e.g., output(s) 345) to a second neural network (e.g., untrained neural network 355) that has an input data dependency that includes data generated by the first neural network. In some examples, based on the input data dependency, the second neural network can be configured to use an output of the first neural network as an input to the second neural network or process input data formed at least partly based on the output of the first neural network.

At block 508, the process 500 can include based on the determination that the first training stage and training of the first neural network are complete, training, using the one or more outputs from the first neural network, the second neural network during a second training stage (e.g., second training stage 340) initiated after completion of the first training stage.

In some aspects, training the first neural network can include updating one or more parameters (e.g., one or more weights, biases, hyperparameters, etc.) of the first neural network during one or more training iterations of the first training stage based on a respective error or loss function value calculated during each training iteration of the first training stage. In some aspects, training the second neural network can include updating one or more parameters (e.g., one or more weights, biases, hyperparameters, etc.) of the second neural network during one or more training iterations of the second training stage based on another respective error or loss function value calculated during each training iteration of the second training stage.

In some aspects, the process 500 can include freezing a plurality of parameters of the first neural network after training of the first neural network during the first training stage is complete and before the second training stage to train the second neural network is initiated. In some examples, freezing the plurality of parameters of the first neural network prevents any updates to the plurality of parameters of the first neural network during the second training stage. In some cases, the plurality of parameters of the first neural network can include all parameters of the first neural network.

In some examples, the first neural network can include a segmentation network and the second neural network can include a centroid prediction network. In some aspects, the process 500 can include applying one or more operations (e.g., operation 230) to the one or more outputs from the first neural network before providing the one or more outputs to the second neural network. In some examples, the one or more operations can include a point masking operation configured to mask or remove one or more datapoints from the portion of the sensor data enclosed within the bounding box based on a determination that the one or more datapoints do not correspond to (e.g., do not belong to, are not part of, do not measure or depict a portion of, etc.) the target in the scene.

In some examples, the first neural network and the second neural network can include or represent a multi-network system. In some aspects, the second neural network can be configured to run at some point sequentially after the first neural network during an inference stage of the multi-network system.

In some aspects, the training data can include sensor data having a bounding box that encloses a portion of the sensor data corresponding to (e.g., that belongs to, that is part of, that measures or depicts a portion of, etc.) a target in a scene. In some examples, the sensor data can include data from a LIDAR sensor and/or a camera sensor.

FIG. 6 illustrates an example processor-based system with which some aspects of the subject technology can be implemented. For example, processor-based system 600 can be any computing device making up local computing device 110, client computing device 170, data center 150, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory; and one or more processors coupled to the memory, the one or more processors being configured to: train, using training data, a first neural network during a first training stage; generate, by the first neural network, one or more outputs after the first training stage and training of the first neural network are complete; based on a determination that the first training stage and training of the first neural network are complete, provide the one or more outputs to a second neural network that has an input data dependency comprising data generated by the first neural network; and based on the determination that the first training stage and training of the first neural network are complete, train, using the one or more outputs from the first neural network, the second neural network during a second training stage initiated after completion of the first training stage.

Aspect 2. The system of Aspect 1, wherein the first neural network comprises a segmentation network and the second neural network comprises a centroid prediction network.

Aspect 3. The system of any of Aspects 1 or 2, wherein the first neural network and the second neural network comprise a multi-network system and wherein, during an inference stage of the multi-network system, the second neural network is configured to run at some point sequentially after the first neural network.

Aspect 4. The system of any of Aspects 1 to 3, wherein, based on the input data dependency, the second neural network is configured to use an output of the first neural network as an input to the second neural network or receive input data formed at least partly based on the output of the first neural network.

Aspect 5. The system of any of Aspects 1 to 4, wherein training the first neural network comprises updating one or more parameters of the first neural network during one or more training iterations of the first training stage based on a respective error or loss function value calculated during each training iteration of the first training stage, and wherein training the second neural network comprises updating one or more parameters of the second neural network during one or more training iterations of the second training stage based on another respective error or loss function value calculated during each training iteration of the second training stage.

Aspect 6. The system of any of Aspects 1 to 5, wherein the one or more processors are configured to freeze a plurality of parameters of the first neural network after training of the first neural network during the first training stage is complete and before the second training stage to train the second neural network is initiated, and wherein freezing the plurality of parameters of the first neural network prevents any updates to the plurality of parameters of the first neural network during the second training stage.

Aspect 7. The system of any of Aspects 1 to 6, wherein the training data comprises sensor data having a bounding box that encloses a portion of the sensor data corresponding to a target in a scene, and wherein the sensor data comprises data from at least one of a light detection and ranging sensor and a camera sensor.

Aspect 8. The system of Aspect 7, wherein the first neural network comprises a segmentation network and the second neural network comprises a centroid prediction network, wherein the one or more processors are configured to apply one or more operations to the one or more outputs from the first neural network before providing the one or more outputs to the second neural network, wherein the one or more operations comprises a point masking operation configured to mask or remove one or more datapoints from the portion of the sensor data enclosed within the bounding box based on a determination that the one or more datapoints do not correspond to the target in the scene.

Aspect 9. A method comprising: training, using training data, a first neural network during a first training stage; generating, by the first neural network, one or more outputs after the first training stage and training of the first neural network are complete; based on a determination that the first training stage and training of the first neural network are complete, providing the one or more outputs to a second neural network that has an input data dependency comprising data generated by the first neural network; and based on the determination that the first training stage and training of the first neural network are complete, training, using the one or more outputs from the first neural network, the second neural network during a second training stage initiated after completion of the first training stage.

Aspect 10. The method of Aspect 9, wherein the first neural network comprises a segmentation network and the second neural network comprises a centroid prediction network.

Aspect 11. The method of any of Aspects 9 or 10, wherein the first neural network and the second neural network comprise a multi-network system and wherein, during an inference stage of the multi-network system, the second neural network is configured to run at some point sequentially after the first neural network.

Aspect 12. The method of any of Aspects 9 to 11, wherein, based on the input data dependency, the second neural network is configured to use an output of the first neural network as an input to the second neural network or receive input data formed at least partly based on the output of the first neural network.

Aspect 13. The method of any of Aspects 9 to 12, wherein training the first neural network comprises updating one or more parameters of the first neural network during one or more training iterations of the first training stage based on a respective error or loss function value calculated during each training iteration of the first training stage, and wherein training the second neural network comprises updating one or more parameters of the second neural network during one or more training iterations of the second training stage based on another respective error or loss function value calculated during each training iteration of the second training stage.

Aspect 14. The method of any of Aspects 9 to 13, further comprising freezing a plurality of parameters of the first neural network after training of the first neural network during the first training stage is complete and before the second training stage to train the second neural network is initiated, and wherein freezing the plurality of parameters of the first neural network prevents any updates to the plurality of parameters of the first neural network during the second training stage.

Aspect 15. The method of any of Aspects 9 to 14, wherein the training data comprises sensor data having a bounding box that encloses a portion of the sensor data corresponding to a target in a scene, and wherein the sensor data comprises data from at least one of a light detection and ranging sensor and a camera sensor.

Aspect 16. The method of Aspect 15, wherein the first neural network comprises a segmentation network and the second neural network comprises a centroid prediction network, wherein the method further comprises: applying one or more operations to the one or more outputs from the first neural network before providing the one or more outputs to the second neural network, wherein the one or more operations comprises a point masking operation configured to mask or remove one or more datapoints from the portion of the sensor data enclosed within the bounding box based on a determination that the one or more datapoints do not correspond to the target in the scene.

Aspect 17. A non-transitory computer-readable medium having stored thereon instructions which, when executed by one or more processors, cause the one or more processors to perform a method according to any of Aspects 9 to 16.

Aspect 18. A system comprising means for performing a method according to any of Aspects 9 to 16.

Aspect 19. A computer-program product having stored thereon instructions which, when executed by one or more processors, cause the one or more processors to perform a method according to any of Aspects 9 to 16.

Aspect 20. An autonomous vehicle comprising one or more computing devices configured to perform a method according to any of Aspects 9 to 16.

What is claimed is:

1. A system comprising:
a memory; and
one or more processors coupled to the memory, the one or more processors being configured to:
train, using training data, a first neural network during a first training stage;
generate, by the first neural network, one or more outputs after the first training stage and training of the first neural network are complete;
based on a determination that the first training stage and training of the first neural network are complete, provide the one or more outputs to a second neural network that has an input data dependency comprising data generated by the first neural network; and
based on the determination that the first training stage and training of the first neural network are complete, train, using the one or more outputs from the first neural network, the second neural network during a second training stage initiated after completion of the first training stage.

2. The system of claim 1, wherein the first neural network comprises a segmentation network and the second neural network comprises a centroid prediction network.

3. The system of claim 1, wherein the first neural network and the second neural network comprise a multi-network system and wherein, during an inference stage of the multi-network system, the second neural network is configured to run at some point sequentially after the first neural network.

4. The system of claim 1, wherein, based on the input data dependency, the second neural network is configured to use an output of the first neural network as an input to the second neural network or receive input data formed at least partly based on the output of the first neural network.

5. The system of claim 1, wherein training the first neural network comprises updating one or more parameters of the first neural network during one or more training iterations of the first training stage based on a respective error or loss function value calculated during each training iteration of the first training stage, and wherein training the second neural network comprises updating one or more parameters of the second neural network during one or more training iterations of the second training stage based on another respective error or loss function value calculated during each training iteration of the second training stage.

6. The system of claim 1, wherein the one or more processors are configured to freeze a plurality of parameters of the first neural network after training of the first neural network during the first training stage is complete and before the second training stage to train the second neural network is initiated, and wherein freezing the plurality of parameters of the first neural network prevents any updates to the plurality of parameters of the first neural network during the second training stage.

7. The system of claim 1, wherein the training data comprises sensor data having a bounding box that encloses a portion of the sensor data corresponding to a target in a scene, and wherein the sensor data comprises data from at least one of a light detection and ranging sensor and a camera sensor.

8. The system of claim 7, wherein the first neural network comprises a segmentation network and the second neural network comprises a centroid prediction network, wherein the one or more processors are configured to apply one or more operations to the one or more outputs from the first neural network before providing the one or more outputs to the second neural network, wherein the one or more operations comprises a point masking operation configured to mask or remove one or more datapoints from the portion of the sensor data enclosed within the bounding box based on a determination that the one or more datapoints do not correspond to the target in the scene.

9. A method comprising:
training, using training data, a first neural network during a first training stage;
generating, by the first neural network, one or more outputs after the first training stage and training of the first neural network are complete;
based on a determination that the first training stage and training of the first neural network are complete, providing the one or more outputs to a second neural network that has an input data dependency comprising data generated by the first neural network; and
based on the determination that the first training stage and training of the first neural network are complete, training, using the one or more outputs from the first neural network, the second neural network during a second training stage initiated after completion of the first training stage.

10. The method of claim 9, wherein the first neural network comprises a segmentation network and the second neural network comprises a centroid prediction network.

11. The method of claim 9, wherein the first neural network and the second neural network comprise a multi-network system and wherein, during an inference stage of the multi-network system, the second neural network is configured to run at some point sequentially after the first neural network.

12. The method of claim 9, wherein, based on the input data dependency, the second neural network is configured to use an output of the first neural network as an input to the second neural network or receive input data formed at least partly based on the output of the first neural network.

13. The method of claim 9, wherein training the first neural network comprises updating one or more parameters of the first neural network during one or more training iterations of the first training stage based on a respective error or loss function value calculated during each training iteration of the first training stage, and wherein training the second neural network comprises updating one or more parameters of the second neural network during one or more training iterations of the second training stage based on another respective error or loss function value calculated during each training iteration of the second training stage.

14. The method of claim 9, further comprising freezing a plurality of parameters of the first neural network after training of the first neural network during the first training stage is complete and before the second training stage to train the second neural network is initiated, and wherein freezing the plurality of parameters of the first neural network prevents any updates to the plurality of parameters of the first neural network during the second training stage.

15. The method of claim 9, wherein the training data comprises sensor data having a bounding box that encloses a portion of the sensor data corresponding to a target in a scene, and wherein the sensor data comprises data from at least one of a light detection and ranging sensor and a camera sensor.

16. The method of claim 15, wherein the first neural network comprises a segmentation network and the second neural network comprises a centroid prediction network, wherein the method further comprises:
applying one or more operations to the one or more outputs from the first neural network before providing the one or more outputs to the second neural network, wherein the one or more operations comprises a point masking operation configured to mask or remove one or more datapoints from the portion of the sensor data enclosed within the bounding box based on a determination that the one or more datapoints do not correspond to the target in the scene.

17. A non-transitory computer-readable medium having stored thereon instructions which, when executed by one or more processors, cause the one or more processors to:
train, using training data, a first neural network during a first training stage;
generate, by the first neural network, one or more outputs after the first training stage and training of the first neural network are complete;
based on a determination that the first training stage and training of the first neural network are complete, provide the one or more outputs to a second neural network that has an input data dependency comprising data generated by the first neural network; and
based on the determination that the first training stage and training of the first neural network are complete, train, using the one or more outputs from the first neural network, the second neural network during a second training stage initiated after completion of the first training stage.

18. The non-transitory computer-readable medium of claim 17, wherein the first neural network comprises a segmentation network and the second neural network comprises a centroid prediction network.

19. The non-transitory computer-readable medium of claim 17, wherein training the first neural network comprises updating one or more parameters of the first neural network during one or more training iterations of the first training stage based on a respective error or loss function value calculated during each training iteration of the first training stage, and wherein training the second neural network comprises updating one or more parameters of the second neural network during one or more training iterations of the second training stage based on another respective error or loss function value calculated during each training iteration of the second training stage.

20. The non-transitory computer-readable medium of claim 17, further comprising instructions that, when executed by the one or more processors, cause the one or more processors to freeze a plurality of parameters of the first neural network after training of the first neural network during the first training stage is complete and before the second training stage to train the second neural network is initiated, and wherein freezing the plurality of parameters of the first neural network prevents any updates to the plurality of parameters of the first neural network during the second training stage.
